(19) United States
(12) Patent Application Publication
(10) Pub. No.: US 2011/0009045 A1
(43) Pub. Date: Jan. 13, 2011

(54) Vehicular Interior Assembly

(76) Inventors: Daniel V. BECKLEY, Byron, MI (US); Clarence P. Lipke, Fenton, MI (US)

Correspondence Address: MAGNA INTERNATIONAL, INC., 337 MAGNA DRIVE, AURORA, ON, L4G-7K1, CA

(21) Appl. No.: 12/832,114

(22) Filed: Jul. 8, 2010

Related U.S. Application Data
(60) Provisional application No. 61/224,267, filed on Jul. 9, 2009.

(51) Int. Cl. B60H 1/24

(52) U.S. Cl. 454/162

(57) ABSTRACT

A vehicular interior assembly including an air duct defining a duct opening having at least one key receiver and a vent that includes a vent body defining a longitudinal axis and a vent opening axially therethrough. At least one key extends outward from the vent body substantially perpendicular to the longitudinal axis and is sized for receipt through the corresponding at least one key receiver. The vent body is axially receivable into the duct opening with the at least one key received through the corresponding at least one key receiver. Rotation of the vent body about its longitudinal axis moves the at least one key from an axial movable position to an axial non-movable position. A trim retention feature disposed on the vent body retains a vehicular trim component against the air duct while the at least one key is in its axial non-movable position.

### CROSS REFERENCE TO RELATED APPLICATIONS

This U.S. patent application claims priority under 35 U.S.C. §119(e) to U.S. Provisional Application 61/224,267, filed on Jul. 9, 2009, which is hereby incorporated by reference in its entirety.

### TECHNICAL FIELD

This disclosure relates to vehicular interior assemblies and to a heating-ventilation-air-conditioning (HVAC) system interfaced with one or more interior trim components.

### BACKGROUND

The automotive industry is increasingly focusing on improvements to the manufacture process as well as the reduction in cost and weight of a vehicle. As a result, while known vehicular components have proven to be acceptable for various applications, such components are nevertheless susceptible to improvements that may enhance or improve the vehicle or its manufacture process. Therefore, a need exists in the art to develop improved vehicular components that advance the art.

### SUMMARY

The present disclosure provides a vehicular interior assembly including a heating-ventilation-air-conditioning (HVAC) portion and one or more interior trim components coupled to the HVAC portion, which may include a duct. The one or more interior trim components may include a vent.

One aspect of the disclosure provides a vehicular interior assembly that includes an air duct defining a duct opening having at least one key receiver and a vent received by the duct opening. The vent includes a vent body defining a longitudinal axis and a vent opening axially therethrough. At least one key extends outward from the vent body substantially perpendicular to the longitudinal axis and is sized for receipt through the corresponding at least one key receiver. The vent also includes a trim retention feature disposed on the vent body. The vent body is axially receivable into the duct opening with the at least one key received through the corresponding at least one key receiver. Rotation of the vent body about its longitudinal axis moves the at least one key from an axial movable position to an axial non-movable position. The trim retention feature retains a vehicular trim component against the air duct while the at least one key is in its axial non-movable position.

Implementations of the disclosure may include one or more of the following features. In some implementations, the duct opening has a non-constant diameter that includes at least a major diameter and a minor diameter. The at least one key receiver is defined along the major diameter. The at least one key receiver may comprise a first key receiver and a second key receiver, where the first key receiver is defined diametrically-opposed to the second key receiver. Moreover, the at least one key may comprise a first key and a second key, with the first and second keys disposed diametrically-opposed on the vent body and arranged for registration with the corresponding first and second key receivers.

In some implementations, the vent includes a locking protrusion extending from the at least one key toward the trim retention feature. The locking protrusion is receivable by a corresponding detent of the air duct when the at least one key is in its axial non-movable position. In additional implementations, the at least one key of the vent defines a detent configured to receive a locking protrusion of the air duct when the at least one key, is in its axial non-movable position.

The vent body may define a cylindrical shape along the longitudinal axis. The at least one key may extend radially outward from the vent body and revolve about the longitudinal axis along a portion of the vent body. A first, leading end of the at least one key axially can be offset from a second, trailing end of the at least one key in a spiraling arrangement that draws the trim retention feature closer to the air duct as rotation of the vent moves the at least one key from its axial movable position to its axial non-movable position.

In some examples, the vent body defines at least one recess for receiving a corresponding projection disposed on the air duct and extending into the duct opening. The at least one recess can be located near the first, leading end and/or the second, trailing end of the corresponding at least one key. The trim retention feature may include an annular protrusion, such as a ring, extending radially outward from one end of the vent body.

Another aspect of the disclosure provides a vehicular interior assembly that includes an air duct defining a duct opening having at least one key receiver and a vent received by the duct opening. The vent includes a vent body defining a cylindrical shape having a longitudinal axis and a vent opening axially therethrough. At least one key extends radially outward from the vent body and revolves about the longitudinal axis along a portion of the vent body. A first, leading end of the at least one key is axially offset from a second, trailing end of the at least one key in a spiraling arrangement. The at least one key is sized for receipt through the corresponding at least one key receiver. The vent also includes a trim retention feature disposed on the vent body. The vehicular interior assembly includes a vehicular trim component defining a ventilation opening for receiving the vent body. The vent body is axially receivable through the ventilation opening of the vehicular trim component and into the duct opening with the at least one key received through the corresponding at least one key receiver. Rotation of the vent body about its longitudinal axis moves the at least one key from an axial movable position to an axial non-movable position. The spiraling arrangement of the at least one key draws the trim retention feature closer to the air duct upon rotation toward the axial non-movable position. The trim retention feature retains the vehicular trim component against the air duct while the at least one key is in its axial non-movable position.

Implementations of the disclosure may include one or more of the following features. In some implementations, the vent body defines at least one recess for receiving a corresponding projection extending from the air duct into the duct opening. The at least one recess may be located near the second, trailing end of the corresponding at least one key. In some examples, the at least one recess comprises an axial groove defined by the vent body.

The duct opening may have a non-constant diameter that includes at least a major diameter and a minor diameter. The at least one key receiver defined along the major diameter. In some implementations, the at least one key receiver comprises a first key receiver and a second key receiver, with the first key receiver defined diametrically-opposed to the second key receiver. Similarly, the at least one key may comprise a first key and a second key, with the first and second keys disposed diametrically-opposed on the vent body and arranged for registration with the corresponding first and second key receivers.

In some examples, the vehicular trim component is a headliner. The trim retention feature may include an annular protrusion extending radially outward from one end of the vent body. The annular protrusion (e.g., ring) provides an even distribution of retention force against the vehicular trim component (e.g., headliner).

In yet another aspect, a vehicular interior assembly includes an air duct defining a duct opening having first and second key receivers and a vent received by the duct opening. The vent includes a vent body defining a longitudinal axis and a vent opening axially therethrough. First and second keys extend outward from the vent body substantially perpendicular to the longitudinal axis and are sized for receipt through the corresponding first and second key receivers. At least one of the keys has a locking feature. A trim retention feature is disposed on the vent body. The vent body is axially receivable into the duct opening with the keys received through the corresponding key receivers. Rotation of the vent body about its longitudinal axis moves the keys from an axial movable position to an axial non-movable position where the locking feature of at least one of the keys is received by a corresponding locking feature receiver of the air duct. The trim retention feature retains a vehicular trim component against the air duct while the keys are in their axial non-movable position.

Implementations of the disclosure may include one or more of the following features. In some implementations, the duct opening has a non-constant diameter that includes at least a major diameter and a minor diameter, with the first and second key receivers defined diametrically-opposed along the major diameter. The first and second keys can be disposed diametrically-opposed on the vent body and arranged for registration with the corresponding first and second key receivers.

In some examples, the locking feature includes a locking protrusion extending from at least one of the keys toward the trim retention feature and the locking feature receiver includes a detent of the air duct. The locking protrusion is receivable by the corresponding detent of the air duct when the keys are in their axial non-movable position. In other examples, the locking feature includes a recess defined by a surface of at least one of the keys facing toward the trim retention feature and the locking feature receiver includes a locking protrusion extending from the air duct. The recess is sized to receive the corresponding locking protrusion when the keys are in their axial non-movable position. The trim retention feature may include an annular protrusion, such as a ring, extending radially outward from one end of the vent body.

The details of one or more implementations of the disclosure are set forth in the accompanying drawings and the description below. Other aspects, features, and advantages will be apparent from the description and drawings, and from the claims.

### DESCRIPTION OF THE DRAWINGS

FIG. 1 is an exploded perspective view of an exemplary vehicular interior assembly.

FIG. 2 is a view of an exemplary heating-ventilation-air-conditioning portion of the vehicular interior assembly of FIG. 1.

FIG. 3A is a sectional view of the heating-ventilation-air-conditioning portion according to line 3A-3A of FIG. 2.

FIG. 3B is a sectional view of the heating-ventilation-air-conditioning portion according to line 3B-3B of FIG. 2.

FIG. 4 is a perspective view of an exemplary interior trim component.

FIG. 5A is a sectional view of the interior trim component according to line 5A-5A of FIG. 4.

FIG. 5B is a sectional view of the interior trim component according to line 5B-5B of FIG. 4.

FIG. 5C is a sectional view of the interior trim component according to line 5C-5C of FIG. 4.

FIG. 6A is a sectional view of the vehicular interior assembly of FIG. 1 in an unassembled state.

FIG. 6B is a sectional view of the vehicular interior assembly of FIG. 1 in a partially assembled state.

FIG. 6C is a sectional view of the vehicular interior assembly of FIG. 1 in an assembled state.

FIG. 7 is a perspective view of an exemplary interior trim component.

FIG. 8 is a partial top view of an exemplary heating-ventilation-air-conditioning portion of the vehicular interior assembly.

FIG. 9 is a partial sectional view of a vehicular interior assembly including the interior trim component of FIG. 7 and the heating-ventilation-air-conditioning portion of FIG. 8.

FIG. 10 is a partial top view of a heating-ventilation-air-conditioning portion of a vehicular interior assembly.

FIG. 11A is a sectional view of the vehicular interior assembly in an unassembled state.

FIG. 11B is a sectional view of the vehicular interior assembly in a partially assembled state.

FIG. 11C is a sectional view of the vehicular interior assembly in an assembled state.

Like reference symbols in the various drawings indicate like elements.

### DETAILED DESCRIPTION

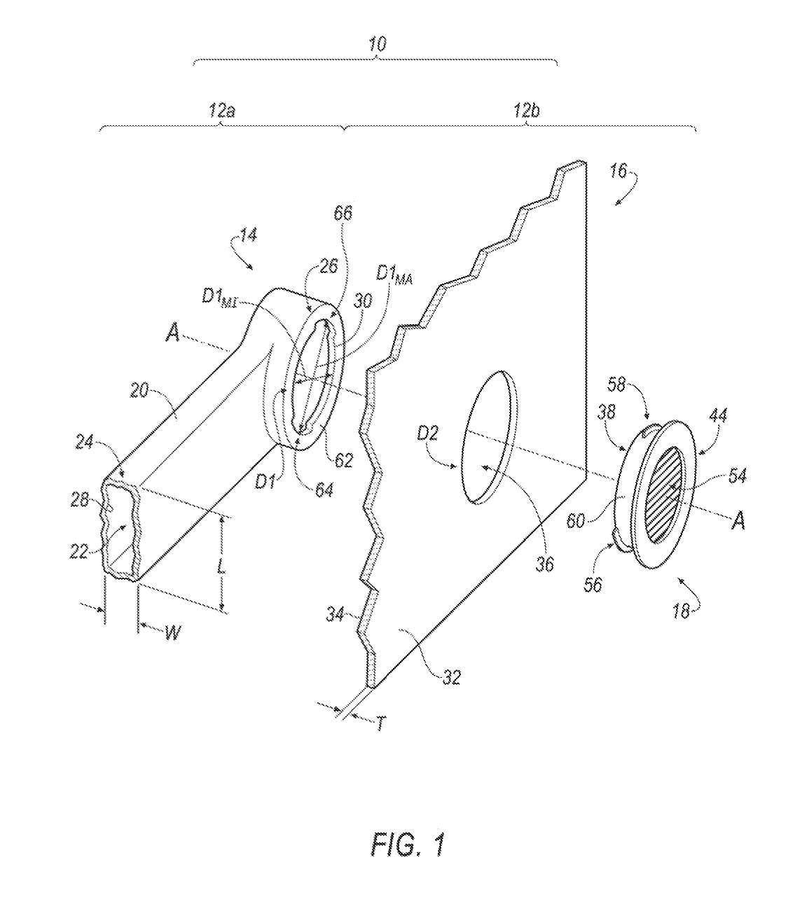

Referring to FIG. 1, in some implementation, a vehicular interior assembly 10 includes a heating-ventilation-air-conditioning (HVAC) portion 12a and one or more interior trim components 12b. The HVAC portion 12a includes an air duct 14 (also referred to as a ‘duct’), which can be used to direct a fluid, such as, heated or cooled air, from a first location to a second location. The one or more interior trim components 12b may include a headliner 16 (and/or other trim panels) and a vent 18.

The duct 14 includes a duct body 20 defining a passageway 22 that may extend from a first end 24 of the duct body 20 to a second end 26 (e.g., a terminal end) of the duct body 20. The duct body 20 may comprise polypropylene (PP), acrylonitrile butadiene styrene (ABS), polycarbonate acrylonitrile butadiene styrene (PC-ABS) or any other suitable material. Moreover, the duct body 20 may be formed by a molding operation (e.g., blow-molding, injection molding, etc.). The vehicular interior assembly 10 defines an axis A-A that may extend through the second end 26 (e.g., through an axial center of the outlet opening 30) of the duct 14, the headliner 16, and the vent 18. The vent 18 may define a longitudinal axis common with the axis A-A.

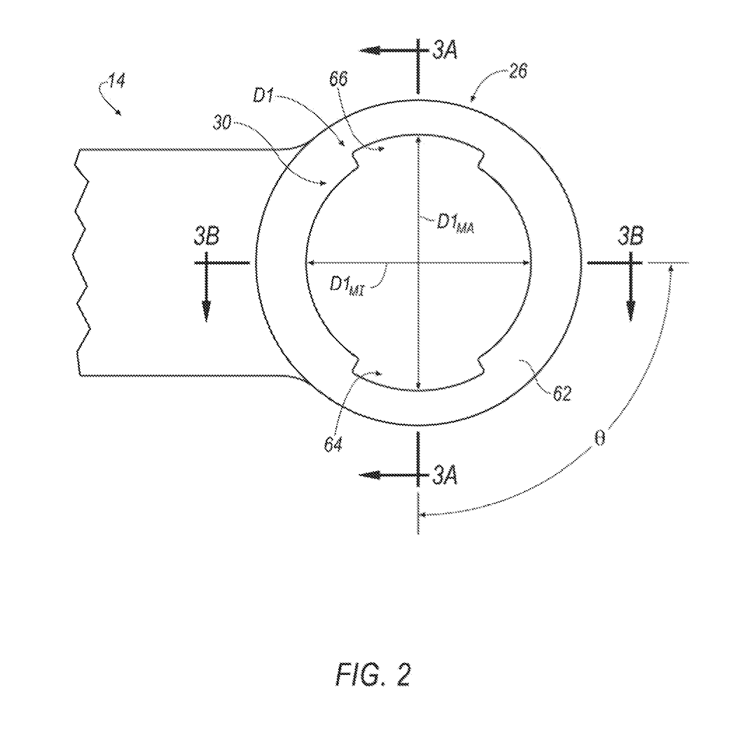

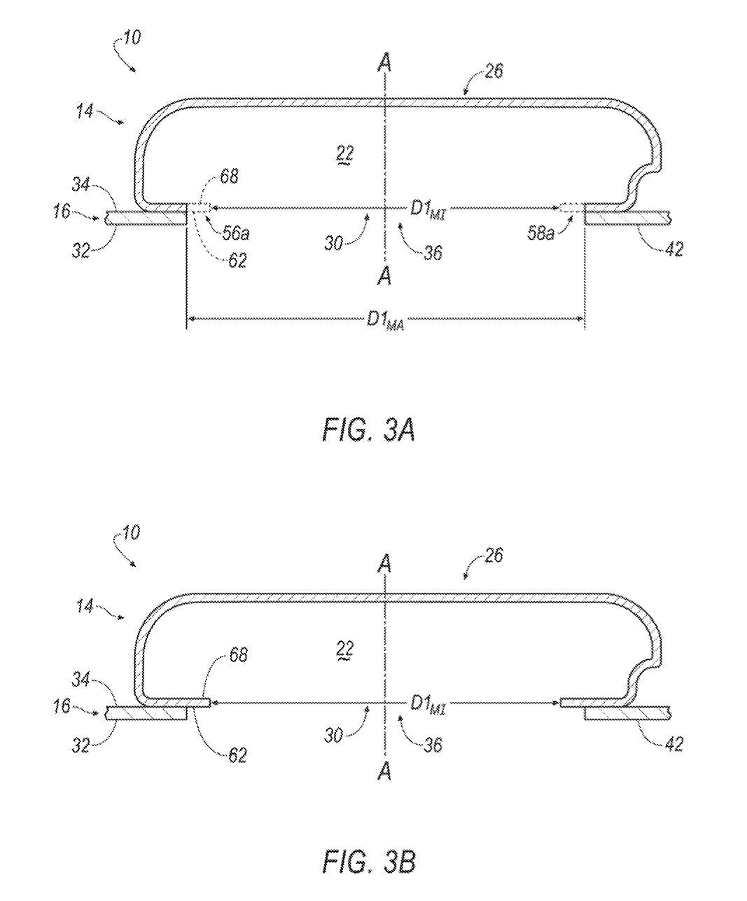

In the example shown, the first end 24 of the duct body 20 defines an inlet opening 28 of the passageway 22, and the second end 26 of the duct body 20 defines an outlet opening 30 of the passageway 22. The inlet opening 28 may define a substantially flat, rectangular shape having a length L and a width W, both sized to permit the duct body 20 to be disposed in a compact space between the headliner 16 and an exterior shell/structure (not shown) of the vehicle. Referring to FIGS. 1-3B, in some implementations, the outlet opening 30 defines a non-constant diameter D1 having a major diameter, D1_{MA} (see e.g., FIGS. 2, 3A) and a minor diameter D1_{MI} (see e.g., FIGS. 2, 3B).

Referring again to FIG. 1, in some implementations, the headliner 16 has a thickness T extending between an inboard, passenger-compartment-side surface 32 and an outboard surface 34 that faces the exterior shell/structure of the vehicle. The headliner 16 defines a passageway 36 that extends though the thickness T of the headliner 16 and has a diameter D2 approximately equal to the major diameter D1_{MA} of the non-constant diameter D1 of the outlet opening 30 of the duct 14.

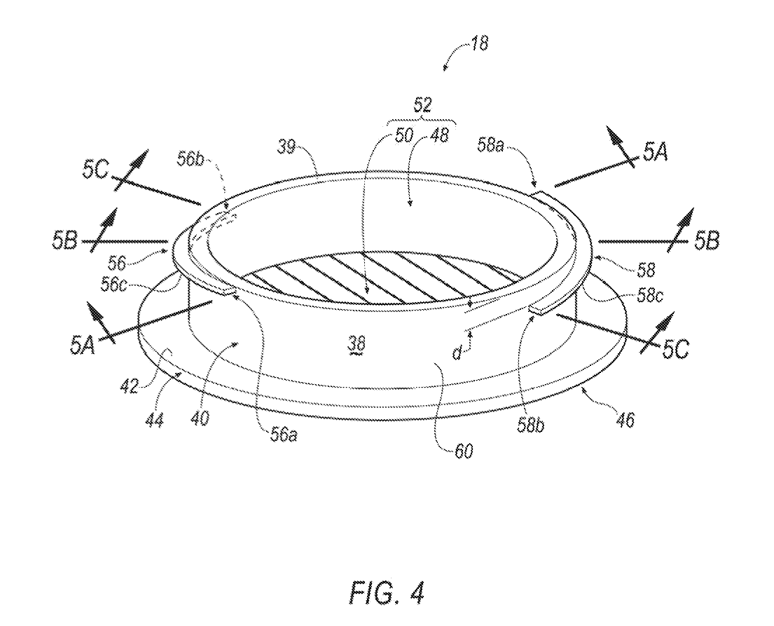

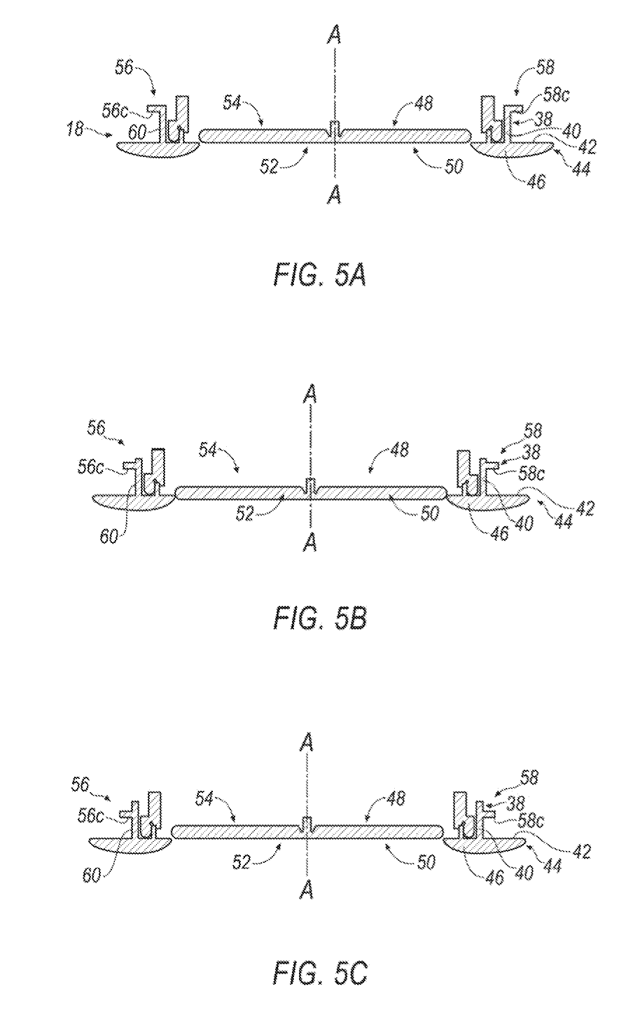

Referring to FIGS. 4-5C, in some implementations, the vent 18 includes a neck 38 defining a substantially ring-shaped body 40 that extends axially away from and substantially perpendicularly with respect to an outboard surface 42 of a head 44 of the vent 18. In the example shown, the vent head 44 defines a substantially flat, ring-shaped body 46 with a passageway 50 in communication with a corresponding passageway 48 defined by the neck 38. Together the passageways 48, 50 of the neck 38 and the vent head 44 define a passageway 52 extending through the vent 18.

In some examples, as shown in FIGS. 1 and 5A-5C, the vent 18 includes one or more closure elements 54 movably arranged within or at least proximate the passageway 52 extending through the vent 18. The one or more closure elements 54 may move (e.g., pivot) between an open position and a closed position to permit/prevent air movement through the passageway 22 of the duct 14, the headliner 16 and the vent 18.

Referring again to FIGS. 4-5C, the neck 38 of the vent 18 may include first and second keys 56, 58 that each extend radially outward from an outer surface 60 of the ring-shaped body 40 of the neck 38. Each key 56, 58 may extend substantially perpendicular from the outer surface 60 of the ring-shaped body 40 of the neck 38 and can be disposed in a ‘ramping’ or ‘spiral’ arrangement relative the neck 38. For example, each key 56, 58 may include a first end 56a, 58a disposed substantially axially co-planar with an upper axial surface 39 of the neck 38, and a second end 56b, 58b disposed axially offset and away from the upper axial surface 39 by an offset distance d (see e.g., FIG. 4). As such, each of the first and second keys 56, 58 wraps around at least a portion of the neck 38 in a spiraling manner, gradually progressing axially away from the upper axial surface 39 while moving along each key 56, 58 from the first end 56a, 58a to the second end 56b, 58b. Although a spiraling key arrangement is shown, other arrangements are possible as well. For example, the first and second keys 56, 58 may wrap around the neck 8 such that a portion of the first and second keys 56, 58 do not spiral or ramp, and/or a portion of the first and second keys 56, 58 proximate the second ends 56b, 58b may include a flat/non-spiraling feature that acts as a seating portion/seating surface of the first and second keys 56, 58.

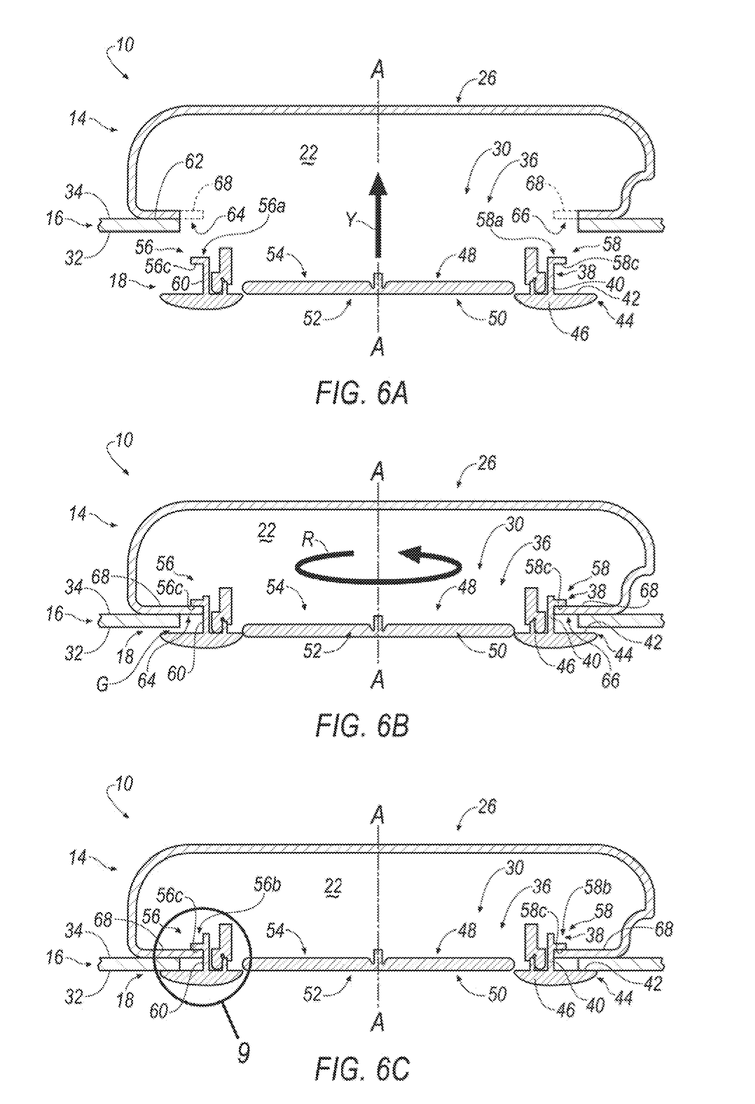

Referring to FIGS. 1 and 6A-6C, operations for assembling the vehicular interior assembly 10 may include disposing an outer surface 62 of the second end 26 of the duct body 20 substantially adjacent the outboard surface 34 of the headliner 16 and connecting the outer surface 62 of the second end 26 of the duct body 20 to the outboard surface 34 of the headliner 16 (e.g., using an adhesive and/or fastener). The operations further include arranging an axial center of the opening 52 of the vent 18 substantially coaxial with an axial center of each of the openings 30, 36 of each of the duct 14 and the headliner 16. Prior to or while aligning the vent 18 with the duct 14 and the headliner 16, the operations may include aligning the first and second keys 56, 58 of the vent 18 with the major diameter D1_{MA} of the outlet opening 30 of the duct 14. The geometry of the neck 38 and the first and second keys 56, 58 of the vent 18 may correspond to the geometry of the non-constant diameter D1 of the duct 14, such that the first and second keys 56, 58 correspond to the major diameter D1_{MA} of the outlet opening 30 of the duct 14.

In some implementations, the outlet opening 30 defines key-slots/key-passages 64, 66 (e.g., about the major diameter D1_{MA} of the outlet opening 30 of the duct 14) for receiving the first and second keys 56, 58. The key-slots/key-passages 64, 66 may permit the first and second keys 56, 58 of the vent 18 to pass through the outlet opening 30 upon aligning the first and second keys 56, 58 with the key-slots/key-passages 64, 66.

Referring to FIGS. 6A-6B, the operations include moving the vent 18 toward the headliner 16 along an axial direction Y, such that the outboard surface 42 of the head portion 44 of the vent 18 is initially located in a substantially non-contacting, opposing relationship adjacent the inboard, passenger-compartment-side surface 32 of the headliner 16. While moving the vent 18 along the axial direction Y, the operations include inserting the neck 38 of the vent 18 through the openings 30, 36 of the duct 14 and headliner 16. The operations further include inserting the first and second keys 56, 58 through the key-slots/key-passages 64, 66/the major diameter D1_{MA} of the outlet opening 30 of the second end 26 of the duct 14 such that the first and second keys 56, 58 are arranged within the passageway 22 of the duct body 20 of the duct 14. If the first and second keys 56, 58 are not aligned with the key-slots/key-passages 64, 66 or the major diameter D1_{MA} of the outlet opening 30 of the second end 26 of the duct 14, the operations include aligning the first and second keys 56, 58 with the key-slots/key-passages 64, 66 or the major diameter D1_{MA}of the outlet opening 30 of the second end 26 of the duct 14 to permit insertion of the neck 38 of the vent 18 through the outlet opening 30 of the of the second end 26 of the duct 14.

The operations include rotating the vent 18 from a free position to an installed position. For example, rotation of the vent 18 in a rotation direction R (see e.g., FIG. 6B) permits an inboard surface 56c, 58c of the first and second keys 56, 58 to come into contact with an inner surface 68 of the second end 26 of the duct body 20, such that the first and second keys 56, 58 are not entirely aligned with the key-slots/key-passages 64, 66 or the major diameter D1_{MA}of the outlet opening 30 of the second end 26 of the duct 14. In implementations where the vent 18 includes the ‘ramping’ or ‘spiral’ arrangement of the first and second keys 56, 58, rotation of the vent 18 causes a gap G (FIG. 6B), or spacing between the outboard surface 42 of the vent 18 and the passenger-compartment-side surface 32 of the headliner 16, to decrease to approximately zero (see e.g., FIG. 6C) positioning the vent 18 adjacent to the headliner 16. When the vent 18 is drawn adjacent the headliner 16, as shown in FIG. 6C, the inboard surfaces 56c, 58c proximate the second ends 56b, 58b of the respective first and second keys 56, 58 are located adjacent the inner surface 68 of the second end 26 of the duct body 20. In some examples, the second ends 56b, 58b of the first and second keys 56, 58 engage the inner surface 68 of the second end 26 of the duct body 20 to cause an interference-fit between the vent 18 and the duct body 20.

In the installed position, as shown in FIG. 6C, the vent 18 may retain the headliner 16 against the duct 14 (e.g., a portion of the headliner 16 may be sandwiched between the vent 18 and the duct 14). In some examples, each of the keys 56, 58 wraps around the neck 38 of the vent 18 approximately 90°. Accordingly, upon rotation of the vent 18 at an angle θ (see e.g., FIG. 2), which may be approximately equal to 900, the spiraling arrangement of first and second keys 56, 58 permits the vent 18 to connect to the duct 14 with a simple two-stroke movement that includes an insertion movement and the axial direction Y, followed by a rotational movement in rotation direction R (e.g., a quarter-turn). The keys 56, 58 allow attachment of the vent 18 to the duct 14 without the use of an adhesive or other fasteners (e.g., screws, rivets). Moreover, since a portion of the headliner 16 proximate the passageway 36 extending through the headliner 16 is ‘sandwiched’ as an intermediate layer between the duct 14 and the vent 18, additional fasteners and/or methods of connecting the headliner 16 to the duct 14 (e.g., using an adhesive) may be eliminated.

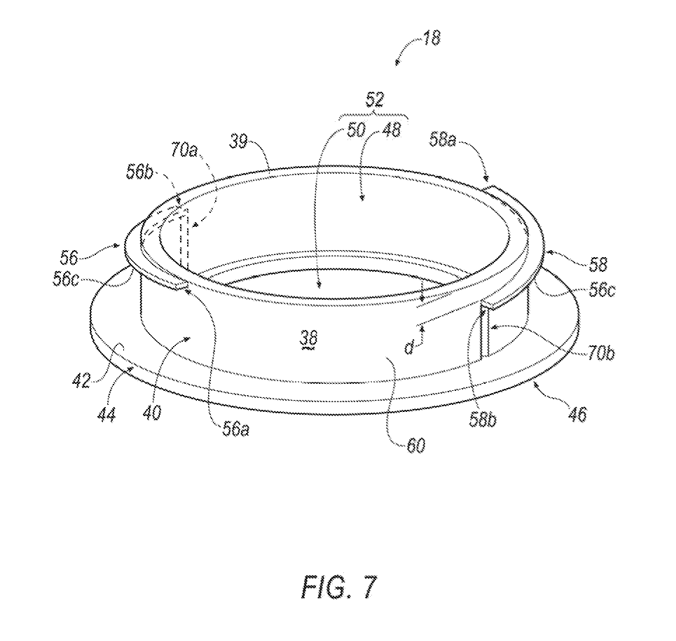

Referring to FIG. 7, in some implementations, the vent 108 includes first and second recesses 70a, 70b that project radially into the outer surface 60 on opposite sides of the ring-shaped body 40 of the neck 38. In the example shown, the recesses 70a, 70b are circumferentially aligned upon the neck 38 with the corresponding second ends 56b, 58b of the keys 56, 58; however, other arrangements are possible as well. For example, the recesses 70a, 70b may be circumferentially offset from the second ends 56b, 58b of the keys 56, 58 such that the recesses 70a, 70b circumferentially trail or lead the second ends 56b, 58b.

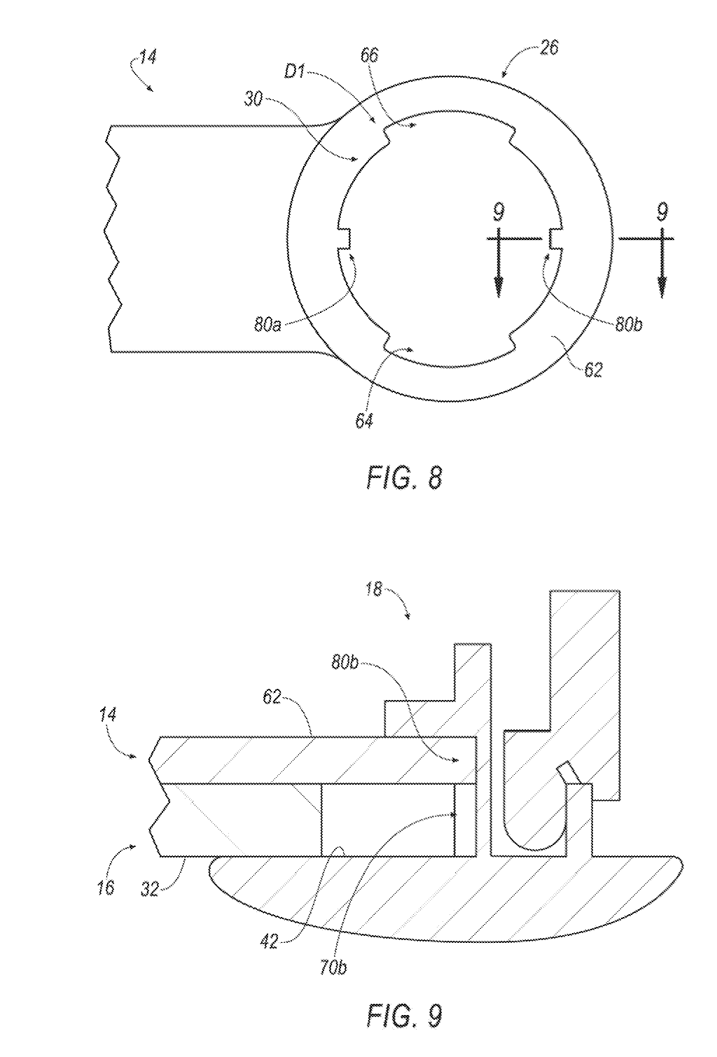

Referring to FIG. 8, in some implementations, the outlet opening 30 of the duct 14 is defined by first and second projections 80a, 80b that project radially inwardly at opposite sides of the outlet opening 30. The projections 80a, 80b further define at least a portion of the minor diameter D1_{MI}. In some examples, the projections 80a, 80b are formed from an elastic material that permits the projections 80a, 80b to recover their size/shape after being elastically deformed.

FIG. 9 provides an enlarged sectional view of a connection of the vent 18 and the duct 14. While inserting the vent 18 along the axial direction Y, and rotating the vent 18 in the rotation direction R, relative to the duct 104 (e.g., as similarly described with reference to FIGS. 6A-6B), the projections 80a, 80b extending from the duct 14 may engage, be deformed by, and drag against the outer surface 60 of the ring-shaped body 40 of the vent 18 until the recesses 70a, 70b of the vent 108 are aligned with the corresponding projections 80a, 80b of the duct 104. Upon alignment of the recesses 70a, 70b with the projections 80a, 80b, the projections 80a, 80b may recover their pre-deformed size/shape and become registered within the corresponding recesses 70a, 70b, thus preventing further rotation of the vent 118 relative the duct 104. In implementations where the recesses 70a, 70b are circumferentially aligned with the second ends 56b, 58b of the first and second keys 56, 58, the projections 80a, 80b register within the recesses 70a, 70b just after the outboard surface 42 of the vent 108 is drawn adjacent the inboard, passenger-compartment-side surface 32 of the headliner 16.

Although the examples shown in FIGS. 7-9 illustrate the vent 18 as including two recesses 70a, 70b and the duct 14 as including two corresponding projections 80a, 80b, any number, arrangement, or configuration of recesses 70a, 70b and corresponding projections 80a, 80b may be implemented. For example, the recesses 70a, 70b may be formed in the duct 14 proximate the outlet opening 30 and projections 80a, 80b may extend radially outwardly from the outer surface 60 on opposite sides of the ring-shaped body 40 of the neck 38.

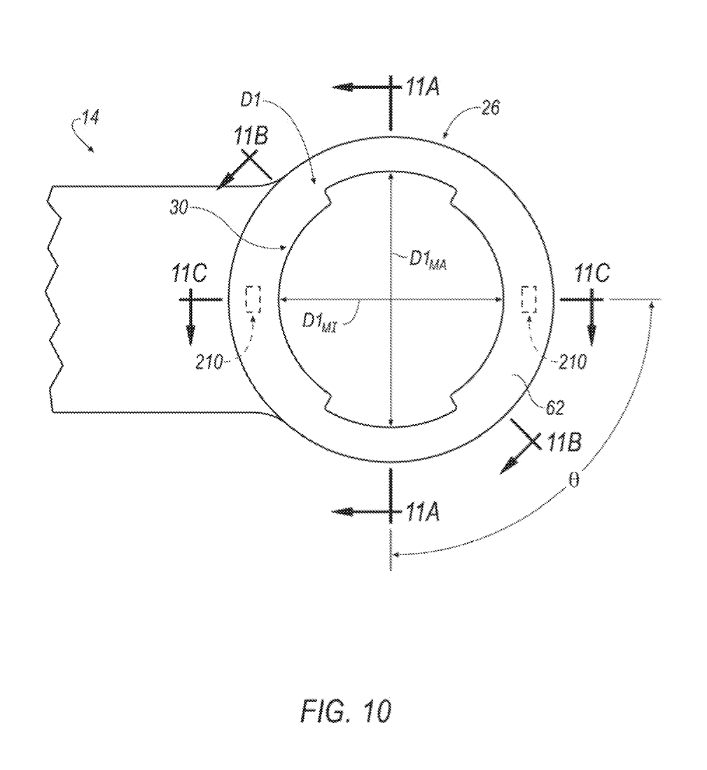

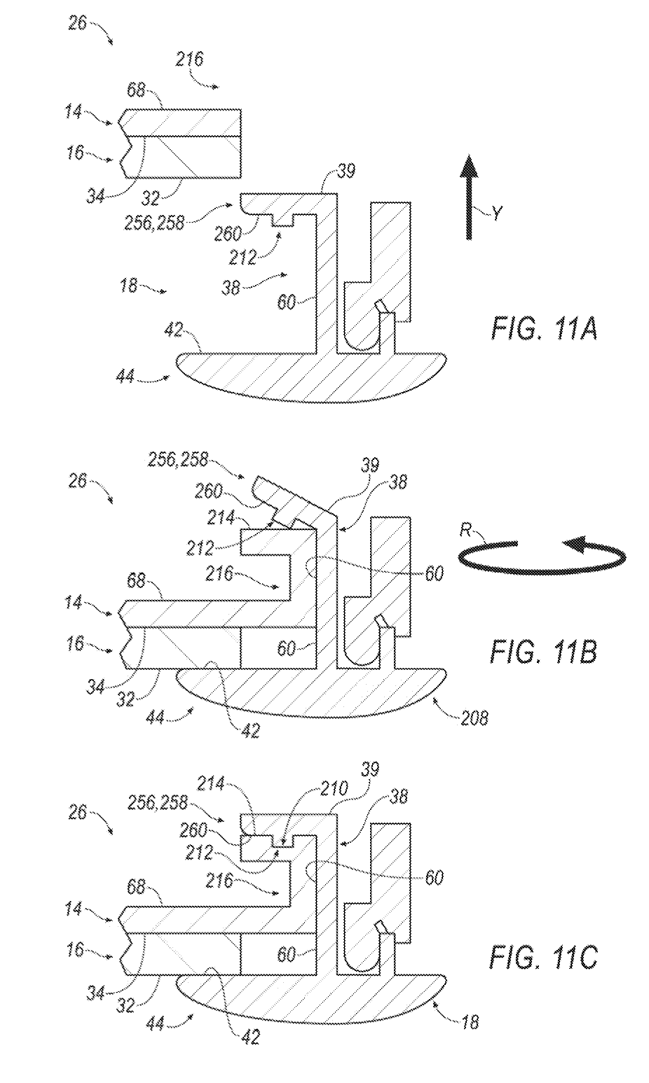

Referring to FIGS. 10-11C, in some implementations, the duct 14 includes a ring-shaped flange 216 having an L-shaped cross-section and extending from the inner surface 68 of the second end 26 of the duct body 20. The flange 216 has an inner surface 214 that defines one or more detents, recesses, divots, or cavities 210 (see FIGS. 11A-11C). In some implementations, the vent 18 includes first and second arms 256, 258 extending radially-outward from the upper axial surface 39 of the neck 38 in a substantially perpendicular manner with respect to the outer surface 60 of the neck 38. The first and second arms 256, 258 are substantially flat and parallel to the inner surface 69 of the duct body 20, rather than having the ‘ramping’ or ‘spiral’ arrangement associated with the first and second keys 56, 58. Because the first and second arms 256, 258 do not include the ‘ramping’ or ‘spiral’ arrangement, the outer surface 60 of the neck 38 is sized with an appropriate length such that the outboard surface 42 of the vent 18 may be located adjacent the inboard, passenger-compartment-side surface 32 of the headliner 16 upon full insertion of the vent 18 through the headliner 16 and duct 14 along the axial direction Y.

In some implementations, an inboard surface 260 of one or more of the first ands second arms 256, 258 includes a locking projection 212 that projects axially away from the inboard surface 260 toward the outboard surface 42 of the vent 18. Each locking projection 212 is receivable by a corresponding detent 210 of the duct 14. The dent 210 may be a mechanism (e.g., catch, lever, recess, cavity) that temporarily keeps one part (i.e., the vent 18) in a certain position relative to that of another (i.e., the duct 14), and can be released by applying force to one of the parts.

As shown in FIG. 11A, the vent 18 may be moved along the axial direction Y, and then, as shown in FIG. 11B, the vent 18, while also being disposed adjacent the inboard, passenger-compartment-side surface 32 of the headliner 16, can be rotated in the rotation direction R. As the one or more projections 212 slide along portions of the inner surface 214 of the ring-shaped flange 216, the first and second arms 256, 258 move from an un-flexed state to a flexed state, elastically deforming substantially away from the inner surface 214 until the vent 18 is rotated to a locking position that aligns the locking projection(s) 212 with the one or more recesses 210, as shown in FIG. 11C. Upon reaching the locking position, the first and second arms 256, 258 move from the flexed state back to a locked state as the locking projection(s) 212 fall into the corresponding one or more recesses 210.

The locking projection(s) 212 received within the one or more recesses 210 prevents free rotation of the vent 18 relative the duct 14. In some examples, registration of locking projections 212 within the recesses 210 may be a permanent, non-serviceable connection (i.e., further rotation of the vent 208 relative the duct 204 is completely prevented), or, alternatively, the registration of the locking projections 212 within the recesses 210 provides a selectively-coupled, serviceable connection (i.e., an application of a sufficient rotating force may result in one or more of the first and second arms 256, 258 moving from the locked state to the flexed state by elastically deforming the first and second arms 256, 258 away from the inner surface 214 of the vent 18, releasing the locking protrusions 212 from their corresponding recesses 210, and moving the vent 18 to an unlocked state). Upon ‘unlocking’ the vent 18 from the duct 14, further rotation of the vent 18 relative the duct 14 may result in the first and second arms 256, 258 being aligned with the key-slots/key-passages 64, 66/the major diameter D1_{MA} such that the vent 18 may be detached /decoupled from one or more of the duct 14 and headliner 16.

Although the examples shown in FIGS. 10-11C illustrate the vent 18 and the duct 14 as include locking projections 212 and recesses 210, respectively, any number, arrangement or configuration of locking projections 212 and recesses 210 may be implemented. For example, recesses may be formed in the vent 18 for receiving locking projections that extend axially away from the inner surface portion 214 of the second end 26 of the duct body 20.

A number of implementations have been described. Nevertheless, it will be understood that various modifications may be made without departing from the spirit and scope of the disclosure. Accordingly, other implementations are within the scope of the following claims.

What is claimed is:

1. A vehicular interior assembly comprising:
an air duct defining a duct-opening having at least one key receiver; and
a vent received by the duct opening, the vent comprising:
a vent body defining a longitudinal axis and a vent opening axially therethrough;
at least one key extending outward from the vent body substantially perpendicular to the longitudinal axis and sized for receipt through the corresponding at least one key receiver; and
a trim retention feature disposed on the vent body;
wherein the vent body is axially receivable into the duct opening with the at least one key received through the corresponding at least one key receiver, rotation of the vent body about its longitudinal axis moving the at least one key from an axial movable position to an axial non-movable position, the trim retention feature retaining a vehicular trim component against the air duct while the at least one key is in its axial non-movable position.

2. The vehicular interior assembly of claim 1, wherein the duct opening has a non-constant diameter that includes at least a major diameter and a minor diameter, the at least one key receiver defined along the major diameter.

3. The vehicular interior assembly of claim 2, wherein the at least one key receiver comprises a first key receiver and a second key receiver, the first key receiver defined diametrically-opposed to the second key receiver.

4. The vehicular interior assembly of claim 3, wherein the at least one key comprises a first key and a second key, the first and second keys disposed diametrically-opposed on the vent body and arranged for registration with the corresponding first and second key receivers.

5. The vehicular interior assembly of claim 1, wherein the vent further comprises a locking protrusion extending from the at least one key toward the trim retention feature, the locking protrusion receivable by a corresponding detent of the air duct when the at least one key is in its axial non-movable position.

6. The vehicular interior assembly of claim 1, wherein the at least one key of the vent defines a detent configured to receive a locking protrusion of the air duct when the at least one key is in its axial non-movable position.

7. The vehicular interior assembly of claim 1, wherein the vent body defines a cylindrical shape along the longitudinal axis, the at least one key extending radially outward from the vent body and revolving about the longitudinal axis along a portion of the vent body, a first, leading end of the at least one key axially offset from a second, trailing end of the at least one key in a spiraling arrangement that draws the trim retention feature closer to the air duct as rotation of the vent moves the at least one key from its axial movable position to its axial non-movable position.

8. The vehicular interior assembly of claim 7, wherein the vent body defines at least one recess for receiving a corresponding projection disposed on the air duct and extending into the duct opening.

9. The vehicular interior assembly of claim 8, wherein the at least one recess is located near the second, trailing end of the corresponding at least one key.

10. The vehicular interior assembly of claim 1, wherein the trim retention feature comprises an annular protrusion extending radially outward from one end of the vent body.

11. A vehicular interior assembly comprising:
an air duct defining a duct opening having at least one key receiver; and
a vent received by the duct opening, the vent comprising:
a vent body defining a cylindrical shape having a longitudinal axis and a vent opening axially therethrough;
at least one key extending radially outward from the vent body and revolving about the longitudinal axis along a portion of the vent body, a first, leading end of the at least one key axially offset from a second, trailing end of the at least one key in a spiraling arrangement, the at least one key sized for receipt through the corresponding at least one key receiver; and
a trim retention feature disposed on the vent body; and
a vehicular trim component defining a ventilation opening for receiving the vent body;
wherein the vent body is axially receivable through the ventilation opening of the vehicular trim component and into the duct opening with the at least one key received through the corresponding at least one key receiver; and
wherein rotation of the vent body about its longitudinal axis moves the at least one key from an axial movable position to an axial non-movable position, the spiraling arrangement of the at least one key drawing the trim retention feature closer to the air duct upon rotation toward the axial non-movable position, the trim retention feature retaining the vehicular trim component against the air duct while the at least one key is in its axial non-movable position.

12. The vehicular interior assembly of claim 11, wherein the vent body defines at least one recess for receiving a corresponding projection extending from the air duct into the duct opening.

13. The vehicular interior assembly of claim 12, wherein the at least one recess is located near the second, trailing end of the corresponding at least one key.

14. The vehicular interior assembly of claim 13, wherein the at least one recess comprises an axial groove defined by the vent body.

15. The vehicular interior assembly of claim 11, wherein the duct opening has a non-constant diameter that includes at least a major diameter and a minor diameter, the at least one key receiver defined along the major diameter.

16. The vehicular interior assembly of claim 15, wherein the at least one key receiver comprises a first key receiver and a second key receiver, the first key receiver defined diametrically-opposed to the second key receiver.

17. The vehicular interior assembly of claim 16, wherein the at least one key comprises a first key and a second key, the first and second keys disposed diametrically-opposed on the vent body and arranged for registration with the corresponding first and second key receivers.

18. The vehicular interior assembly of claim 11, wherein the vehicular trim component comprises a headliner.

19. The vehicular interior assembly of claim 11, wherein the trim retention feature comprises an annular protrusion extending radially outward from one end of the vent body.

20. A vehicular interior assembly comprising:
an air duct defining a duct opening having first and second key receivers; and
a vent received by the duct opening, the vent comprising:
a vent body defining a longitudinal axis and a vent opening axially therethrough;
first and second keys extending outward from the vent body substantially perpendicular to the longitudinal axis and sized for receipt through the corresponding first and second key receivers, at least one of the keys having a locking feature;
a trim retention feature disposed on the vent body; and
wherein the vent body is axially receivable into the duct opening with the keys received through the corresponding key receivers, rotation of the vent body about its longitudinal axis moving the keys from an axial movable position to an axial non-movable position where the locking feature of at least one of the keys is received by a corresponding locking feature receiver of the air duct, the trim retention feature retaining a vehicular trim component against the air duct while the keys are in their axial non-movable position.

21. The vehicular interior assembly of claim 20, wherein the duct opening has a non-constant diameter that includes at least a major diameter and a minor diameter, the first and second key receivers defined diametrically-opposed along the major diameter.

22. The vehicular interior assembly of claim 21, wherein the first and second keys are disposed diametrically-opposed on the vent body and arranged for registration with the corresponding first and second key receivers.

23. The vehicular interior assembly of claim 20, wherein the locking feature comprises a locking protrusion extending from at least one of the keys toward the trim retention feature and the locking feature receiver comprises a detent of the air duct, the locking protrusion receivable by the corresponding detent when the keys are in their axial non-movable position.

24. The vehicular interior assembly of claim 20, wherein the locking feature comprises a recess defined by a surface of at least one of the keys facing toward the trim retention feature and the locking feature receiver comprises a locking protrusion extending from the air duct, the recess sized to receive the corresponding locking protrusion when the keys are in their axial non-movable position.

25. The vehicular interior assembly of claim 20, wherein the trim retention feature comprises an annular protrusion extending radially outward from one end of the vent body.
